(19) United States
(12) Patent Application Publication
(10) Pub. No.: US 2009/0074819 A1
(43) Pub. Date: Mar. 19, 2009

(54) POLYMERIC NANO-SHELLS

(76) Inventors: Daniel Cohn, Jerusalem (IL); Gilad Lando, Rishon LeZion (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/719,247

(22) PCT Filed: Nov. 15, 2005
(86) PCT No.: PCT/IL2005/001203

§ 371 Date: May 14, 2007

(30) Foreign Application Priority Data
Nov. 16, 2004 (IL) 165260

(51) Int. Cl. A61K 47/32; C08J 3/05; C07K 1/00; A61K 9/00

(52) U.S. Cl. 424/400; 524/457; 530/333; 514/772.3; 977/840; 977/906

(57) ABSTRACT

The present invention provides a method for manufacturing polymeric nano-structures (nano-shells), wherein the nano-structures are hollow and respond to a temperature change by reversibly changing their volume, and the method comprises the steps of providing a polymer forming supramolecular structures when dispersed in a liquid environment, dispersing the polymer in a liquid environment to form the supramolecular structures and crosslinking the supramolecular structures, where the crosslinking occurs with the structures, whereby the nano-shells are obtained. The nano-structures manufactured according to the present invention are useful in sequestering, transporting, or scavenging hydrophobic or hydrophilic materials.

### FIELD OF THE INVENTION

The present invention relates to polymeric nano-structures based on amphiphilic polymers, which structures are substantially hollow and respond to a temperature change by changing their volume.

### BACKGROUND OF THE INVENTION

Engineering nano-sized structures such as liposomes, dendrimers, and polymeric micelles, is a growing area of contemporary Biomaterials Science, due to their large potential in a diversity of biomedical applications, including, e.g., biosensors and drug delivery. A variety of complex, supramolecular, assemblies have been developed, including the core-shell knedels of Wooley's group [Thurmond K. B. et al.: J. Am. Chem, Soc. 119 (1999) 6656-65], polymeric micelles of Eisenberg's group [Allen C. et al.: Yu Y. et al.: Bioconjugate Chem. 9 (1998) 564-72], copolymeric nano-tubes [Stewart S. et al.: Angew, Chem. Int. Ed. 39 (2000) 340-4], etc.

“Smart” polymers are an advanced class of materials tailored to display substantial property changes as a response to minor chemical, physical or biological stimuli, such as temperature, pH, biochemical agents, mechanical stresses, and electrical fields. Environmentally responsive polymers have attracted special attention over the last decade due to both their complexity and versatility, as well as to their application in various areas. The term “thermo-responsive” refers to the ability of a polymeric system to achieve significant chemical, mechanical or physical changes due to small temperature differentials. Reverse thermo-responsive polymers exhibit a sharp viscosity increase with temperature within a narrow temperature interval, reversibly producing a gel from a low viscosity water solution. This endothermic phase transition takes place at a temperature called the Lower Critical Solution Temperature (LCST). The Reverse Thermal Gelation (RTG) phenomenon provides promising strategies for the development of injectable polymers that will form a semi-solid gel at body temperature. Grafting thermo-responsive chains onto the surface of various nanoparticles, or blending said particles with a non-responsive matrix, may render the nano-particles responsive to temperature differentials. For example, poly(N-isopropylacrylamide) or poly(N-vinylisobutyramide) chains were grafted onto polystyrene [Sakuma S. et al.: Adv. Drug Delivery Rev. 47 (2001) 21-37], and poly(N-isopropylacrylamide) was grafted onto polypeptide microcapsules [Kidchob T. et al.: J. Controlled Rel. 50 (1998) 205-14]. A crosslinked core-shell microgel based on poly(N-isopropylacrylamide) was described, formed in a two stage process in which first the core was formed, and then the particles functioned as nuclei for the formation of the shell [Gan D. et al.: J. Am. Chem. Soc. 123 (2001) 7511-7]. Due to their core-shell structure, these assemblies displayed only a limited, surface-confined, ability to respond to temperature changes. Much work focuses on poly (ethylene oxide)/polypropylene oxide)/poly(ethylene oxide) (PEO-PPO-PEO) triblocks. The reverse thermo-responsive behavior of these amphiphilic triblocks stems from their ability to self-assemble into diverse liquid crystalline topologies, driven by the entropy gain provided by the release of bound water molecules structured around the hydrophobic segment [Vadnere M. et al.: Int. J. Pharm. 22 (1984) 207-18]. PEO-PPO-PEO triblocks, commercially available as Pluronics™, have been investigated for drug solubilization and controlled release [Esposito E. et al.: Int. J. Pharm. 142 (1996) 9-23], for the prevention of post-surgical tissue adhesions [Steiner A. et al.: Obstetrics and Gynecology 77 (1991) 48-52], and in wound covering [Mohammed M. et al.: J. Periodontal Res. 33(6) (1998) 335-44.]. However, the potential of thermo-responsiveness and related phenomena displayed by polymeric systems has not yet been fully utilized for the formation of discrete compartments applicable, e.g., in drug delivery. It is therefore an object of the invention to provide discrete nano-structures based on amphiphilic polymers.

It is further an object of the invention to provide essentially hollow nano-structures comprising an amphiphilic polymer.

It is a still further object of the invention to provide nano-structures, reversibly responding to temperature changes, capable of sequestering components in their substantially hollow core.

Other objects and advantages of present invention will appear as description proceeds.

### SUMMARY OF THE INVENTION

The invention relates to a method for manufacturing stable polymeric nano-structures (nano-shells), wherein said nano-structures are substantially hollow and respond to a temperature change by reversibly changing their volume, comprising the steps of: i) providing a polymer forming supramolecular structures when dispersed in a liquid environment; and ii) dispersing said polymer in a liquid environment to form said supramolecular structures and crosslinking said supramolecular structures, wherein said crosslinking occurs substantially within said structures, whereby said stable nano-shells are obtained. In a preferred embodiment of the invention, said polymer is an amphiphilic polymer which is dispersed in a liquid environment, and is crosslinked after forming supramolecular structures in said environment, which crosslinking stabilizes said structures and leads to the formation of said nano-shells. Said supramolecular structure is preferably a micelle, and said amphiphilic polymer is preferably a reverse thermo-responsive polymer. A method of the invention is preferably applied in an aqueous environment. Said polymer comprises preferably an amp hihic copolymer comprising polyethylene oxide (PEO). Said polymer preferably comprises a hydrophobic segment, which may be selected, for example, from the group consisting of polypropylene oxide) (PPO), poly(tetramethylene oxide) (PTMO), poly(caprolactone) (PCL), polyaactic acid) (PLA), and combinations thereof. Said cross-linking, in the method of the invention, comprises functionalizing said polymer with a moiety capable of forming covalent linkage/s under conditions in which said supramolecular structures are not disrupted. In a preferred embodiment of the invention, a method for manufacturing said polymericic nano-shell comprises the addition reaction of vinyl group, such as, for example, vinyl group in a derivative of acrylic acid, etc. In a preferred embodiment of the invention, said cross-linking comprises a reaction of methacrylate. Said cross-linking is preferably achieved by involving methacrylate chains which are end-capped on said polymer.

The invention further relates to a method for manufacturing a polymer nano-structure (nano-shell), wherein said nano-structure is substantially hollow and responds to a temperature change by changing its volume, comprising the step of i) providing a polymer comprising a PEO-(PPO)PEO triblock; ii) end-capping said triblock with acrylate or methacrylate moiety; iii) mixing the end-capped polymer from step ii) in water at elevated temperature, thereby obtaining an emulsion comprising micelles; and iv) crosslinking said acrylate or methacrylate residues in said micelles, preferably in the presence of a catalyst, thereby obtaining said substantially hollow nano-shells. The crosslinking reaction can be performed by directly reacting the terminal end-groups of said polymer or by reacting said terminal end-groups with a crosslinking agent able of reacting with the reactive terminal groups. In one embodiment said reactive terminal groups may be methacrylate moieties that can then react with a crosslinking agent via a free radical mechanism or a Michael addition reaction. In another embodiment said reactive terminal groups may be the reactive end groups present in said polymer, for example the hydroxyl end groups of PEO-PPO-PEO polymers, and the crosslinking molecule may be any molecule able of reacting with said end groups under the conditions required.

Said crosslinking is mainly intramicellar. In one embodiment, said nano-shells may be essentially spherical. The spherical nano-shells may be obtained when mixing the end-capped polymer at an elevated temperature that is below about 65°. Said nano-shells may be rod-like nano-particles. Such rod-like nano-structures are usually obtained when said mixing of the end-capped polymer occurs at an elevated temperature that is higher than about 65°. However, certain applications may require more complex structures, such as chains or nets of nano-shells. The invention enables to obtain more complex structures, for example by controlled, partially intermicellar, crosslinking. Said nano-shells may have a morphology of a chain of beads. In a preferred embodiment of the invention, the nano-shells comprise PEO-PPO-PEO dimethacrylate. During the preparation of the nano-shells from Pluronic™ PEO-PPO-PEO dimethacrylate, the end-capped polymer has preferably a concentration of about 0.2% or less. The invention enables to obtain more complex structures, for example by blending more than one polymer. In one embodiment, said polymers may display the transition at different temperatures, whereby said nano-shells will expand or shrink at different temperatures. The invention also enables to obtain more complex structures, for example, by blending more than one polymer able to generate micelles comprising chains of the different polymers. In one embodiment, the different polymers, preferably amphiphilic, may differ in their molecular weight. In one embodiment, the polymer having a lower molecular weight may be end-capped with reactive groups, while the longer polymer may be end-capped with other segments performing other functions. Since the latter will protrude from the surface of the nano-shell formed by the shorter end-capped polymer, the protruding chains will be able to render the nano-shells with additional features by being able to develop specific interaction with their surroundings.

The invention provides a polymer nano-construct (nano-shell) comprising a cross-linked supramolecular structure of a polymer, preferably an amphiphilic polymer. Said supramolecular structure is preferably a micelle. The nano-shell according to the invention is substantially hollow, and responds to a temperature change by changing its volume. Said polymer preferably comprises PEO-PPO-PEO triblock. In a preferred embodiment of the invention, the triblock is end-capped with methacrylate moiety. The nano-shell of the invention responds to a temperature increase by decreasing its volume, and to a temperature decrease by increasing its volume. Said temperature change occurs preferably in a temperature interval of 25 to 45° C., and still more preferably in a temperature interval of 28 to 40° C. Said nano-shell may change its volume by about two orders of magnitude. Said nano-shell may change its volume even by about three orders of magnitude, or more. A nano-shell according to the invention may be prepared so as to be biodegradable, for example by comprising lactoyl units or caprolactone units.

The invention is also directed to a nano-shell as described above, for use in sequestering materials dispersed in a liquid environment. In a preferred embodiment, said material is a hydrophobic material, and said environment is an aqueous mixture. A nano-shell according to the invention may be used in such a manner that said sequestering may lead to concentrating said material, or to transporting said material, or to scavenging said material. Said material may be of a pharmaceutical or medical importance, e.g., being a medicament. A nano-shell according to the invention is preferably utilized as a drug delivery means. A nano-shell according to the invention may be also utilized for scavenging a medically or pharmaceutically undesired component, or for lowering the concentration of an undesired component, or for mitigating a harmful effect of such an undesired component. A nano-shell according to the invention may be utilized in releasing a pharmaceutically or medically important substance in vivo, which releasing may be associated with decreasing the volume of said nano-shell in response to a temperature increase.

### BRIEF DESCRIPTION OF THE DRAWINGS

The above and other characteristics and advantages of the invention will be more readily apparent through the following examples, and with reference to the appended drawings, wherein:

FIG. 1. demonstrates the temperature response of spherical shells;

FIG. 2. shows the stability of thermo-responsive properties of the spherical shells over time;

FIG. 3. presents spherical nano-shells at TEM;

FIG. 4. shows rod-like nano-shells at TEM;

FIG. 5. demonstrates the temperature response of rod-like nano-shells as characterized by TEM;

FIG. 6. presents TEM micrographs of nano-shells produced under varying temperatures;

FIG. 7. presents DSC thermograms and X-ray diffraction patterns of F-127, F-127-DMA and nano-shells; and

FIG. 8. shows inter-micellar binding leading to the formation of nano-shell assemblies at TEM;

### DETAILED DESCRIPTION OF THE INVENTION

It has now been surprisingly found by the present inventors that crosslinked micelles of an amphiphilic polymer possess very unique properties, forming nano-structures that are substantially hollow and which respond to a temperature change by changing their volume. It has further been found that a surprising level of sequestering of. a-hydrophobic component may be attained in an aqueous mixture comprising said nano-structures.

Said structures, also called nano-shells hereafter, exhibit marked changes of size in response to temperature variations. The nano-shells were specifically obtained by dispersing a polymer comprising PEO-PPO-PEO triblock and PEO/PPO chain extended multiblocks end-capped with a methacrylate moiety.

The invention also relates to essentially hollow polymeric nano-structures comprising PEO-PPO-PEO triblock and PPEO/PPO chain extended multiblocks end-capped with a methacrylate moiety. The nano-structures of the invention are capable to sequester and to transport in their hydrophobic core components dispersed in aqueous environment, preferably hydrophobic components. The hollow nano-structures of the invention may have various shapes, and are distinctly responsive to the changes of temperature—substantially reducing their volume as the temperature rises, the effect being reversible. Where the term nano-structure is used, the inclusion of any polymeric particle is intended, having at least one dimension of the order of hundreds of nanometers or less.

The invention further provides a method for preparing nano-sized essentially hollow structures (nano-shells) responding to a temperature change by changing its volume, comprising dissolving a polymer, preferably an amphiphilic polymer, in a liquid environment and forming a supramolecular structure of said polymer, followed by crosslinking said supramolecular structure, thereby affixing it and obtaining said nano-shells. The term supramolecular structure, as used herein, is to be taken to mean, an assembly of polymer molecules that are bonded by non-covalent interactions (electrostatic, van der Waals, hydrophobic, entropic driven, and other interactions), wherein the dimensions of said assembly are not greater than, in order of the magnitude, micrometers.

An amphiphilic polymer in the method of the invention preferably comprises PEO-PPO-PEO triblock end-capped with methacrylate. Although the nano-shells were obtained with various PEO-PPO-PEO triblocks, as well as various PEO/PPO copolymers, the basic features of the presently generated nano-shells are illustrated and exemplified with PEO₉₉-PPO₆₇-PEO₉₉. This triblock, known as F127, has a molecular weight of 12,600 and comprises 70 wt % PEO. In a preferred embodiment of the invention, the reverse thermo-responsive nano-constructs, nano-shells, are formed via a two stage process. First, the PEO-PPO-PEO dimethacrylate derivatives (F127-DMA) are obtained by the reaction of the native OH-terminated PEO-PPO-PEO triblock with methacryloyl chloride. Once F127-DMA forms micelles in an aqueous medium, they are crosslinked intra-micellarly using a known method, for example employing ascorbic acid, ferrous sulfate, and ammonium persulfate (APS) redox system [Sun et al.: Acta Biochimica et Biophysica Sinica 30(4), 407 (1998)]. For said end-capping, other than acrylate moieties may be used, such that the functionalized polymer preferably retains its original ability to generate the supramolecular structure.

In some exemplified embodiments, the functionalization of the triblock was followed by FTIR, which showed the gradual appearance of weak bands at 1713 cm⁻¹ and 1635 cm⁻¹, corresponding to the carbonyl vibration of the ester group and to the vinyl double bond, respectively. In addition, ¹H-NMR analysis demonstrated the incorporation of methacryloyl groups, as revealed, for example, by the protons of the double bond appearing as duplets at 5.6 ppm and 6.2 ppm. Furthermore, the average-molecular weight and polydispersity were determined by GPC. The relative values obtained were M_{w}=19,600 and Mₙ=15,300 for F127, and M_{w}=21,900 and Mₙ=16,600 for F127-DMA, the polydispersity values being approximately the same for both copolymers, M_{w}/Mₙ=1.3. The viscosity versus temperature curves of F127 and F127-DMA water solutions revealed that the methacrylate moieties has only a marginal effect on PEO-PPO-PEO's reverse thermo-responsiveness. It was found that F127-DMA retains the ability to undergo the sol-gel transition, with only a minor shift of the temperature of gelation, being discernible. Working under conditions that ensured the formation of well separated F127-DMA micelles, for example 0.2% wt, the reactive methacrylate groups end-capping the PEO chains, were covalently bound intra-micellarly by free radical polymerization. Even though the overall F127-DMA concentration was kept rather low to avoid inter-micellar cross-linking, the intra-micellar crosslinking is high. The covalent nature of the obtained supramolecular assemblies was demonstrated by their re-dispersion in aqueous medium, after being lyophilized and immersed in chloroform. The fact that the nano-shells were barely affected by this process, retaining their geometry and their reverse thermo-responsiveness, proved that these are covalently crosslinked nano-constructs.

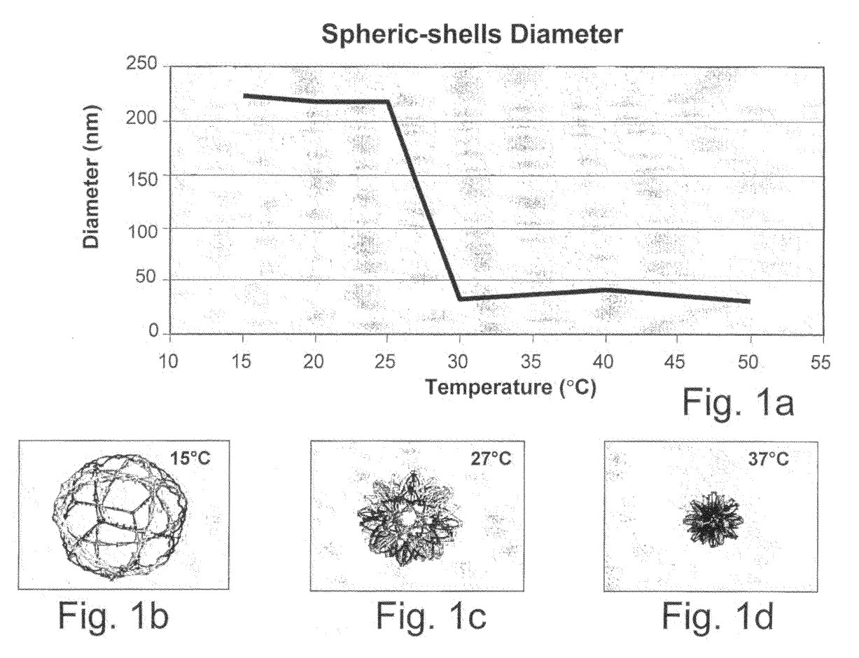

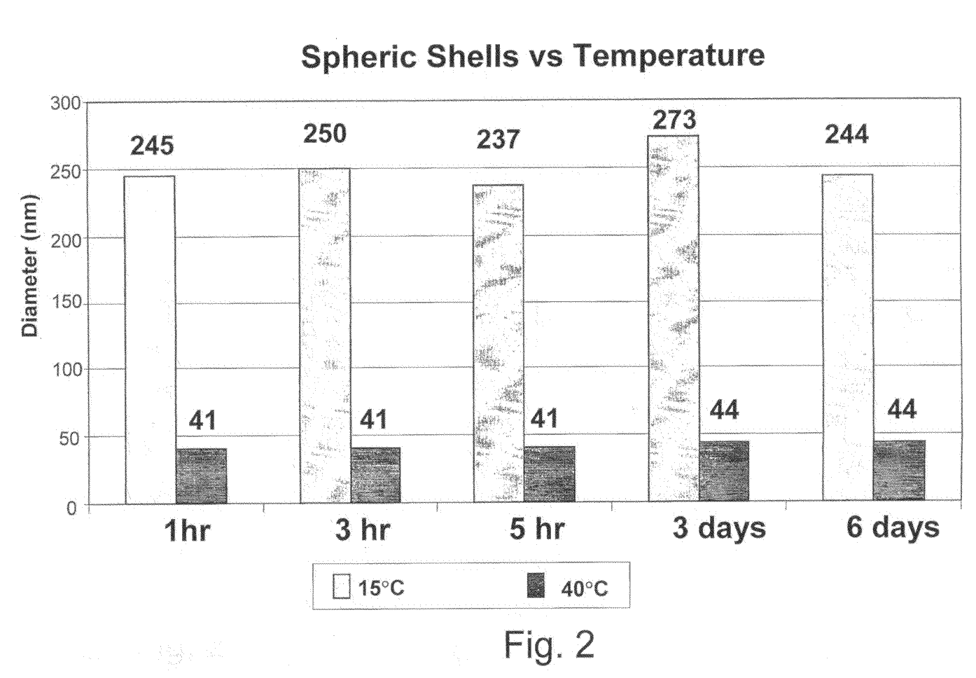

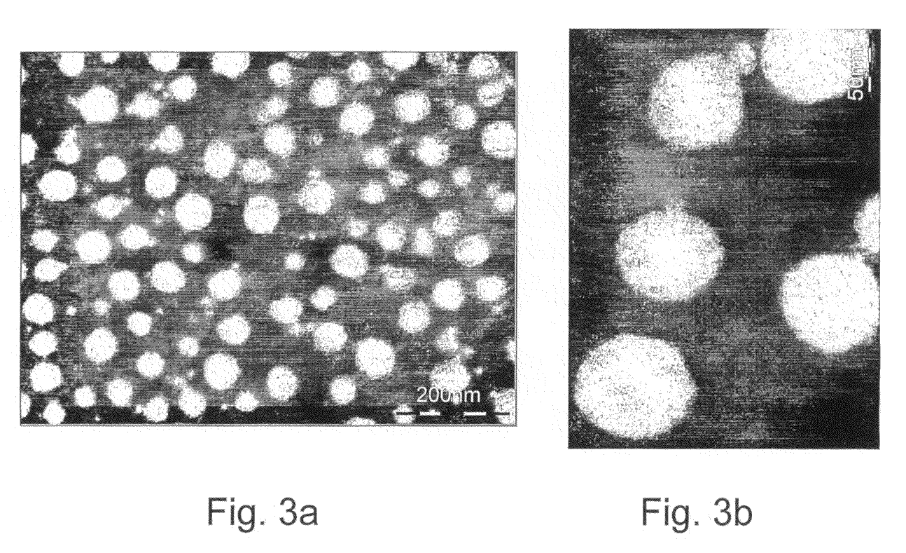

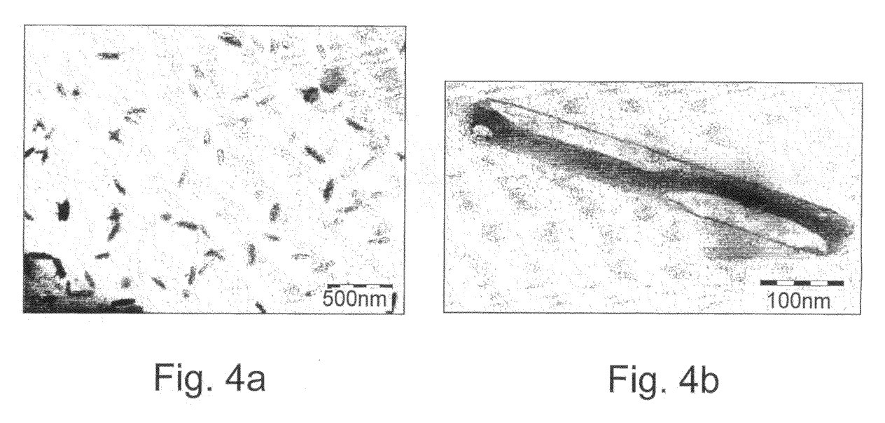

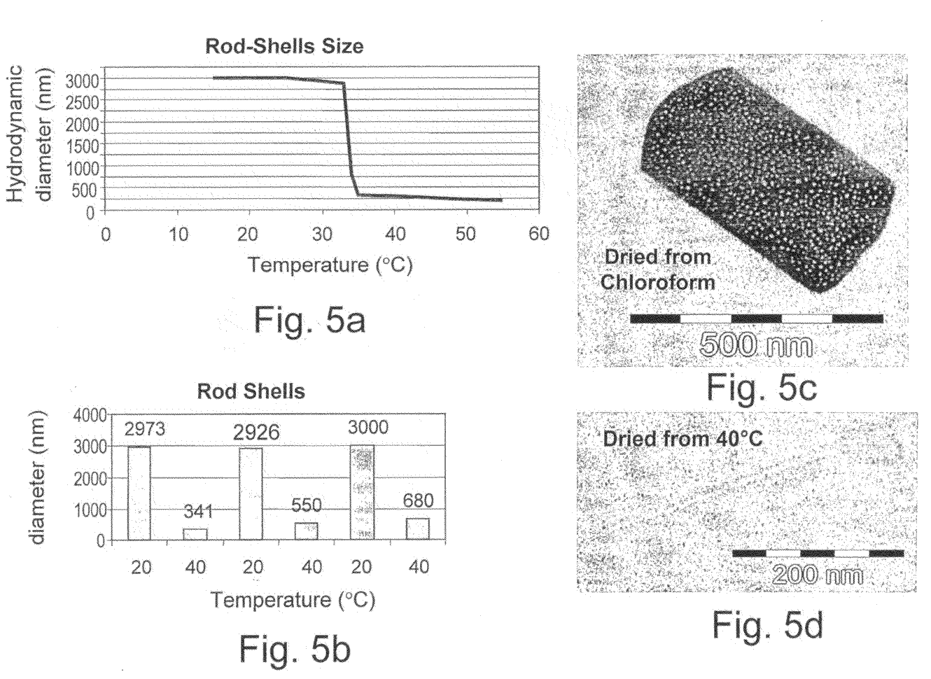

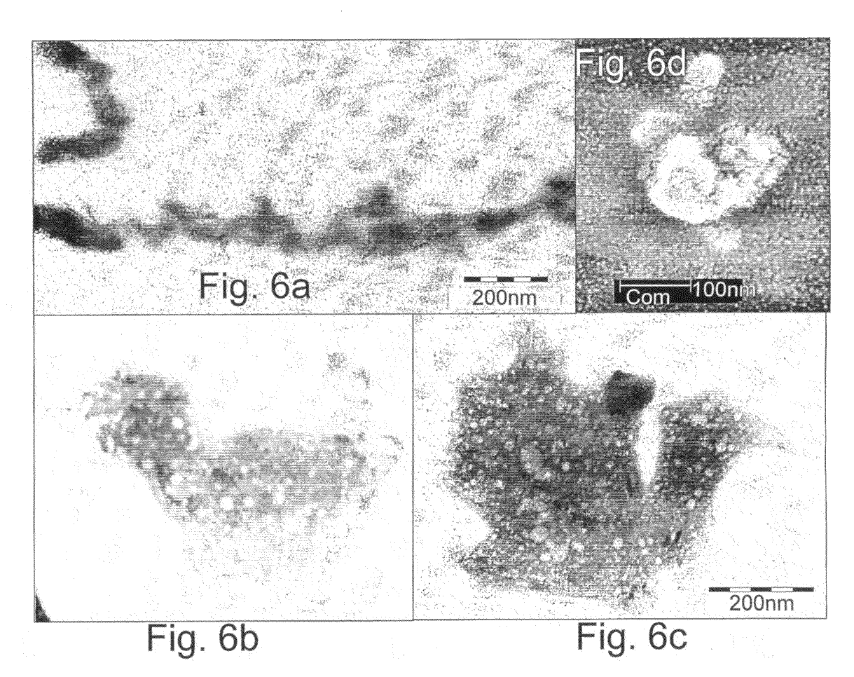

The cross-linking of the hydrophilic PEO case not only stabilizes the micelles resulting in sturdy nano-constructs, but renders them also with a unique thermo-responsive behavior. The temperature-dependent dimensional response of these nano-structures is illustrated in FIG. 1, which reveals a sharp transition, with the nano-shells shrinking dramatically (about 400 times by volume), as temperature rises between 25° C. and 30° C. The TEM micrographs presented in FIG. 3, show the spherical nano-structures formed. FIG. 2 presents the reversible dimensional response of the micelles before and after being crosslinked, at 15° C. and 40° C. The temperatures were chosen so as to be unquestionably below and above their respective transition values. It is apparent from the data that non-crosslinked and crosslinked F127-DMA display totally different behavior as a function of temperature. F127 triblocks appear as molecular unimers at low temperatures and they form a micelle at a higher temperature. For example, at 15° C., the size of F127 unimers is 6-7 nanometers, while the micelles attain a size of around 20 nanometers, at 40° C. Once the temperature decreases below the critical micellization temperature (cmt), the micelles disassemble, reverting to their unimeric state. In fundamental contrast to the above, the engineered nano-sized constructs decrease in size markedly when going from a lower temperature to a higher one, in a sharp and essentially reversible manner. The nano-shells formed exhibit a diameter of around 200 nanometers at 15° C., while displaying a markedly smaller size (approximately 40 nanometers) at 40° C. The behavior of the nano-shells disclosed hereby can also be exemplified by using PEO₁₉-PPO₅₄-PEO₁₉ (P103). This triblock is shorter than F127 (MW 4950) and its unimers and micelles have a size of around 4 and 19 nm, respectively. Nano-shells built using P103 displayed thermo-responsiveness, decreasing from their 850 nm expanded configuration at low temperature, down to 49 nm, above their transition. The striking ability displayed by these supramolecular assemblies to expand and contract reversibly, triggered by a temperature change, is an important feature of the nano-shells and renders them with unique properties, unattainable until now. The shape and size of micelles may depend on the temperature [Mortensen K. et al.: Macromolecules 28 (1995) 8829-34], and therefore, nano-shells having various geometries were “sculptured” by performing the cross-linking reaction at different temperatures. Since F127 generates rod-like micelles at a higher temperature, F127-DMA triblocks were cross-linked at 80° C. The TEM micrographs shown in FIGS. 4(a) and (b), demonstrate that well-defined nano-tubes, were generated. Below 32° C., these rod-like nano-shells had a length of several microns, and they contracted remarkably as the temperature was rising between 33° C. and 35° C., attaining a length of around 300 nanometers at 37° C. (see FIG. 5(a)). The reversibility of the temperature-triggered dimensional response of the rod-like nano-shells is demonstrated in FIG. 5(b), as their size fluctuates for three cycles at temperatures below. (15° C.) and above (40° C.) their critical micellization temperature (cmt). Even though DLS size measurements have limited accuracy when applied to non-spherical particles, the basic nano-tubular geometry and the remarkable contractibility of the nano-shells are unquestionable. The fact that these nano-tubes are cross-linked was demonstrated by their insolubility in chloroform. Interestingly, though, their aspect ratio decreased once re-dispersed in water, becoming less slender then prior to their immersion in chloroform (see FIG. 5(c)). This finding may indicate that some degree of anisotropic swelling occurred, with the system deforming differently in circumferential and longitudinal directions. Spherical nano-shells were formed at 50-65° C., whereas rod-like geometries prevailed between 70-80° C. At temperatures around 90° C. and 95° C., very large nano-tubes and plaque-like structure were produced, respectively. Furthermore, when the temperature was varied during the cross-linking reaction, nano-shells displaying additional geometries, were produced. For example, when the cross-linking reaction was initially conducted at 50° C. and completed at 80° C., the spherical micelles formed at the beginning changed as temperature approached 80° C., trying to accommodate tubular geometrical features, resulting in accordion-like constructs, as shown in FIG. 6(a). Further peculiar geometries were also produced by changing the spatial configuration of the micelle as the cross-linking process was underway, by varying the temperature of the system FIG. 6(b-d).

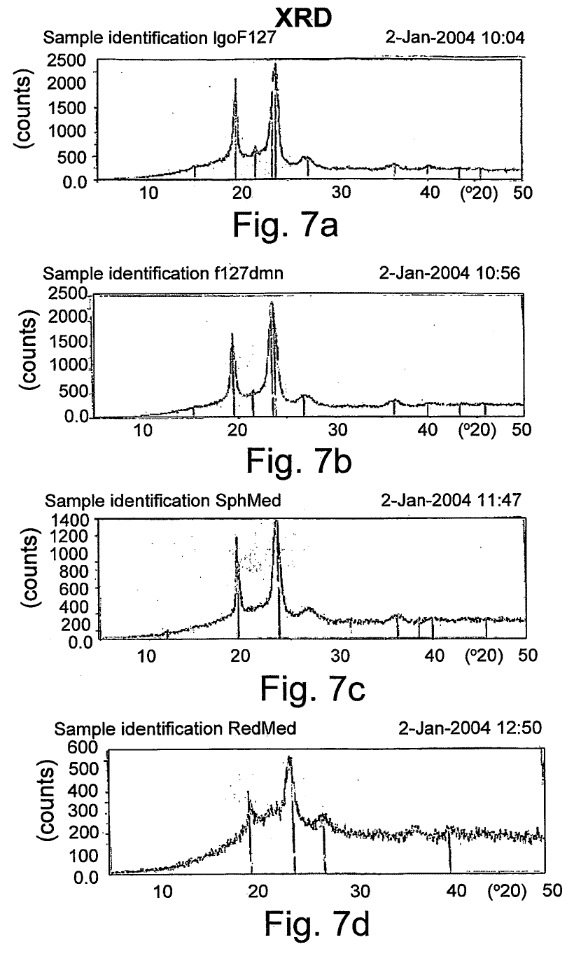

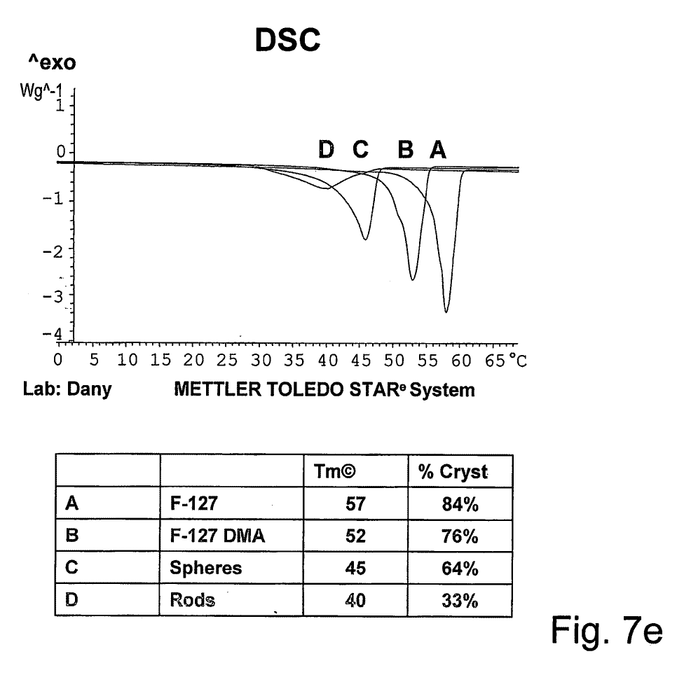

The DSC thermograms and X-ray diffraction patterns presented in FIG. 7, demonstrate that the geometry into which the nano-shells were affixed, spherical versus rod-like, hampered the crystallizability of the dry PEO chains to different extents. When comparing the crystallizability of F127, of its dimethacrylate derivative and of the spherical and rod-like structures, a steady decrease in the degree of crystallinity of the PEO chains, was apparent.

The outer case of the nano-shell and the core space in the cross-linked PEO-PPO-PEO nano-shells of the invention have their special roles. Since the very interface between these novel nano-constructs and the aqueous medium consists of PEO chains, these structures benefit also from the recognized enhanced biocompatibility of PEO chains. Furthermore, the ability of PEO segments to extend the blood circulation time by avoiding reticuloendothelial system uptake represents an additional beneficial feature of the nano-shells.

The nano-structures of the invention are capable of binding hydrophobic materials in their cavities/lumens. The loading capacity of the nano-shells is illustrated here for Sudan III, a small hydrophobic molecule, as revealed by its uptake by rod-like nano-shells at different temperatures. At 5° C., when these large tubular nano-constructs are fully expanded, the amount of Sudan III loaded was negligible. This behavior, is attributed to the very large size of the core space, which fails to generate an environment able to solubilize this hydrophobic payload and, as a result, Sudan III precipitated out of the aqueous medium. At 37° C., though, when the core space is much smaller, approximately 60% of the payload added to the water system (5% wt) was actually loaded into these assemblies. The ability of the nano-shells to incorporate large payloads is illustrated by comparing their behavior to that of F127 micelles, which were able to incorporate only around 35% of the payload.

The nano-shells of the invention, thus, provide a means for sequestering a component which is substantially insoluble in an aqueous mixture, and possibly concentrating it, or isolating, or transporting it. In a preferred embodiment of the invention, the nano-shells are used as a drug-delivery means. It is also worth stressing that typical polymeric micelles are known to be unstable under in vivo conditions, due to the infinite dilution effect and the impact of mechanical stresses on their integrity. However, the nano-shells of the invention do not suffer such drawbacks.

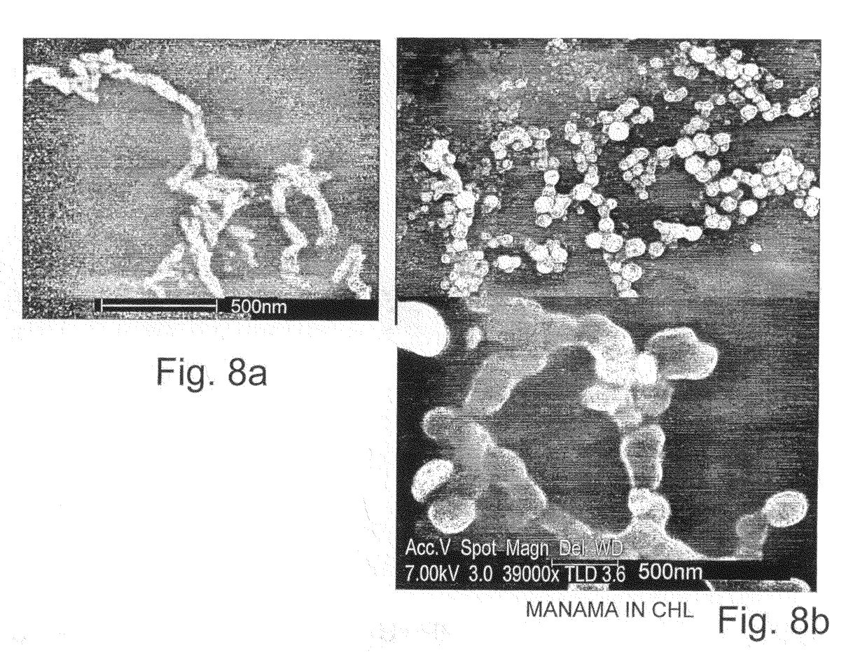

Various methods known in the art may be used for further modifications of the nano-shells of the invention. In a preferred embodiment, the reactive double bonds present at the outer surface of the supramolecular structures can be used as anchoring sites for further derivatizations, using various synthetic pathways, comprising, e.g., free radical mechanism, Michael reaction, or other reactions known in the art. Said reactive double bonds can be used preferably during the synthesis of the nano-shells and even more preferably towards the end of the synthesis of the nano-shells, or once the synthesis has been substantially completed. For example, by adding amine-terminated chains at different stages of the process, inter-micellar binding was performed and additional constructs were formed. FIG. 8 shows pearl necklace-structures formed by binding already well developed, but still reactive nano-shells using amine-terminated poly(oxypropylene oxide) (MW=2000) chains. The surface reactivity of the nano-shells can be used to impart to them additional features, as exemplified by the end-capping of poly(acrylic acid) chains onto the periphery of these assemblies. It is understood that some applications will require quenching of any residual surface activity of the nano-shells, which may be achieved by the reactions known in the art.

The nano-shells are expected to be responsive not only to temperature, but also to pH. Furthermore, it is anticipated that the presence of the poly(acrylic acid) chains will render them mucoadhesive. By end-capping specific biological motifs, these nano-shells can also be of potential as vehicles for targeted drug delivery. The combination of the high “payload” with said targetability, underscores the large potential of the nano-structures of the invention for drug and gene delivery.

In a preferred embodiment of the invention, the nano-shells were rendered biodegradable by binding short degradable segments, comprising, among others, lactoyl (LA) repeating units (up to 8) to each side of the triblock prior to the reaction with methacryloyl chloride to produce the respective methacrylates. The presence of short LA blocks (2 and 4 lactoyl repeating units on each side) did not affect the behavior neither the size of the nano-shells, but the nano-shells became biodegradable. Even rather long blocks, consisting of 8 LA units on each side, produced constructs that retained their reverse thermo-responsiveness, but the assemblies tended to coalesce after 24 hours. Nano-shells based on other components were modified accordingly, following the same basic synthetic approach.

The invention will be further described and illustrated in the following examples.

### EXAMPLES

### Materials

The solvents used were of analytical grade and were dried adding molecular sieves 4A (BDH). Pluronic F127, Pluronic F103, tin octanoate, 2-isocyanatoethylmethacrylate and Sudan III were purchased from Sigma, methacryloyl chloride, stannous octanoate and L-ascorbic acid from Aldrich, triethylamine (TEA) and ammonium peroxodisulfate from Riedel de-Haen, ferrous sulfate from Fluka, and lactide from Boehringer Ingelheim. Methacryloyl chloride was distilled before use.

Synthesis of PEO-PPO-PEO dimethylmethacrylate 40.1 g (3.2 mmol) of Pluronic F127 was dried at 120° C. under vacuum for two hours at three-neck flask. Then, the polymer was dissolved in 75 ml of dry chloroform and the solution was cooled to 0° C. in an ice bath. 2.63 g of TEA. (26.3 mmol) were added. 2.65 g (26.3 mmol) of freshly distilled methacryloyl-chloride were diluted in 20 ml chloroform and added dropwise for 2 hours into the cooled mixture under a dry nitrogen flow and magnetic stirring. Finally, the reaction was allowed to proceed for 24 hours at room temperature. The crude product was dried under vacuum and was re-suspended in hot toluene (100 ml). The hot mixture was filtered in order to remove the triethylammonium hydrochloride salt. The toluene solution was received in 400 ml of petroleum ether 60-80° C. The white solid product, Pluronic F127 dimethacrylate (F127 DMA), was filtered in vacuum, washed with several portions of petroleum ether 40-60° C. and dried under vacuum at room temperature (about 80% yield).

### Synthesis of PEO-PPO-PEO (P127) diisocyanatoethylmethacrylate

40.1 g (3.2 mmol) of Pluronic F127 was dried at 120° C. under vacuum for two hours at three-neck flask. Then, the polymer was cooled to 70° C. in an oil bath. 0.16 g of tin octanoate (0.32 mmol) were added. 0.97 g (6.4 mmol) of dried 2-isocyanatoethylmethacrylate were diluted in 1 ml dioxane and added dropwise into the mixture under a dry nitrogen flow and magnetic stirring. Finally, the reaction was allowed to proceed for 2 hours at 70° C. The crude product was dissolved in chloroform (100 ml). The mixture was precipitated in 400 ml of petroleum ether 60-80° C. The white solid product, Pluronic F127 diisocyanatoethylmethacrylate (F127 DIMA), was filtered under vacuum, washed with several portions of petroleum ether 40-60° C. and dried under vacuum at room temperature (about 80% yield).

### Synthesis of PEO-PPO-PEO (P103) diisoevanatoethylmethacrylate

30 g (6.06 mmol) of Pluronic P103 was dried at 120° C. under vacuum for two hours at three-neck flask. Then, the polymer was cooled to 70° C. in an oil bath. 0.32 g of tin octanoate (0.64 mmol) were added. 19.4 g (12.8 mmol) of dried 2 isocyanatoethylmethacrylate were diluted in 2 ml dioxane and added dropwise, into the mixture under a dry nitrogen flow and magnetic stirring. Finally, the reaction was allowed to proceed for 2 hours at 70° C. The crude product was dissolved in chloroform (100 ml). The mixture was precipitated in 400 ml of petroleum ether 60-80° C. The white solid product, Pluronic F103 diisocyanatoethylmethacrylate (F103 DIMA), was filtered in vacuum, washed with several portions of petroleum ether 40-60° C. and dried under vacuum at room temperature (about 80% yield).

### Preparation of the Nano-Shells

0.4 g of F127 dimethacrylate was dissolved in 200 ml of distilled water. The solution was heated to 50° C. to obtain spherical shells, or 80° C. to obtain rod shells. For spherical shells, 8 mg of the initiator, ammonium peroxodisulfate together with 2 mg of ferrous (II) sulfate and 2 mg of L-ascorbic acid were dissolved in 0.1 ml water and added to the solution. For rod shells, double amounts of initiator and catalysts were used. The reaction was stirred at a constant temperature for 8 hours for spheres, and 24 hours for rods.

### Preparation of a “Necklace” Structure

“Pearl-necklaces” were prepared by a reaction between lyophilized shells and amine-terminated poly(oxypropylene oxide)-W=2000). 3.1 mg of amine-terminated poly(oxypropylene oxide) were added to 40 mg of lyophilized rod-shells on a dry plate at 60° C. for 2 hours.

Preparation of F-127-di-LA2

0.119 gram of lactide was added to 50 gram of dry Pluronic F127, and 0.8 mg of the catalyst, stannous octanoate, was added. The reaction was carried out at 145° C. for 150 minutes, in a dry N₂ environment and with magnetic stirring.

Preparation of F-127-di-LA8

0.476 gram of lactide was added to 50 gram of dry Pluronic F127, and 3.2 mg of the catalyst, stannous octanoate, was added. The reaction was carried out at 145° C. for 150 minutes, in a dry N2 environment and with magnetic stirring.

### Synthesis of F-127-di-PLA-di-methylmethacrylate

40.1 g (3.2 mmol) of F-127-di-PLA was inserted into three-neck flask. Then, the copolymer was dissolved in 75 ml of dry chloroform and the solution was cooled to 0° C. in an ice bath. 2.63 g of TEA (26.3 mmol) was added, and 2.65 g (26.3 mmol) of freshly distilled methacryloyl chloride was diluted in 20 ml chloroform and added dropwise for 2 hours into the cooled mixture under a dry nitrogen flow and magnetic stirring. Finally, the reaction was allowed to proceed for 24 hours at room temperature. The crude product was dried under vacuum and was re-suspended in hot toluene (100 ml). The hot mixture was filtered in order to remove the triethylammonium hydrochloride salt. The toluene solution was received in 400 ml of petroleum ether 60-80° C. The white solid product, (F127-DPLA-DMA), was filtered in vacuum, washed with several portions of petroleum ether 40-60° C. and dried under vacuum at room temperature.

### Preparation of Biodegradable Nano-Shells

Nano-shells polymerization was achieved by dissolving 0.4 g of F127-diPLA-dimethacrylate in 200 ml of distilled water. The solution was heated to 50° C. for spherical shells or 80° C. for rod shells. For spherical shells, 8 mg of the initiator, ammonium peroxodisulfate together With 2 mg of ferrous sulfate and 2 mg of L-ascorbic acid were dissolved in 0.1 ml water and added to the solution. For rod shells, double amounts of Initiator and catalysts were used. The reaction was stirred at constant temperature for 8 hours—for the spheres, and for 24 hours for the rods.

### Gel Permeation Chromatography (GPC)

The average-molecular weights, molecular weight distribution and polydispersity (Mw/Mn) were determined by gel permeation chromatography (Differential Separations Module Waters 2690 with refractometer detector Waters 410 and Millenium Chromatography Manager), using polystyrene standards between 472 and 360,000 Dalton.

### Nuclear Magnetic Resonance Spectroscopy (NMR)

1H Nuclear magnetic resonance spectra was performed in a Bruker 300 MHz NMR (spectrometer operating at 300 MHz for 1H measurements). All spectra were obtained at room temperature from 15% (wt/v) CDCl₃ solutions.

### Infrared Spectroscopy (FTIR)

The characterization of the functional groups was carried out by FTIR analysis using a Nicolet Avatar 360 FTIR spectrometer. The samples were prepared by solvent casting from chloroform solutions, directly on sodium chloride crystals (Aldrich).

### Thermal Analysis

Thermal analysis was carried out by differential scanning calorimetry (DSC) (Mettler Toledo 822e). The samples were sealed in 40 μl Al-crucible pans and their weight was kept between 18-22 mg. The material was lyophilized with liquid nitrogen to remove water for 24 hours, and than subjected to a run were it was heated up from −20° C. to 100° C., at 5° C./min rate. The enthalpy of fusion was obtained from the area of the peak relative to the baseline.

### X-Ray Diffraction Analysis,

A Rigaku RU200 X-ray generator with Cu anode and a Rigaku D-Max/B diffractometer were used to obtain the X-ray diffraction patterns.

### Transmission Electron Microscopy

Samples were lyophilized with liquid nitrogen to remove water for 24 hours. The lyophilized material was re-dissolved in chloroform or water (for concentrated solution) and dried on the grid at room temperature, 40° C. or 5° C. FEI TEM Technai 12 was used at 100 KV.

### Dynamic Light Scattering

The average hydrodynamic radius of the microstructures present in the solutions was measured by dynamic light scattering (HPPS, HPP5001, Malvern Instruments, U.K) in 4 ml polymethylmethacrylate disposable cuvettes. The particle size was taken as the mean value of 4 measurements. The solutions concentration were 0.2% w/w.

### Drug Loading Test

2 mg of Sudan III were introduced into 20 ml of 0.2% w/w nano-shell solutions. The solutions were heated from 5° C. to the desired temperature. After 2 hours of magnetic stirring the solution was filtered and to extract solid Sudan III that was not sequestered in the nano-shells. 2 ml of the solution were dried and re-dissolved in ethanol to determine the Sudan III loading by spectroscopy. The measurements were carried out in a Bausch and Lomb Spectronic 2000 instrument. The concentration of the red color was determined at %=505 nm. While this invention has been described in terms of some specific examples, many modifications and variations are possible. It is therefore understood that within the scope of the appended claims, the invention may be realized otherwise than as specifically described.

1. A method for manufacturing polymeric nano-structures (nano-shells), wherein said nano-structures are substantially hollow and respond to a temperature change by reversibly changing their volume, comprising the steps of
i) providing a polymer forming supramolecular structures when dispersed in a liquid environment; and
ii) dispersing said polymer in a liquid environment to form said supramolecular structures and crosslinking said supramolecular structures, wherein said crosslinking occurs substantially within said structures, whereby said stable nano-shells are obtained.

2. A method according to claim 1, comprising the steps of
i) providing an amphiphilic polymer;
ii) dispersing said polymer in a liquid environment and forming a supramolecular structure of said polymer; and
iii) crosslinking said supramolecular structure, thereby stabilizing it and obtaining said nano-shell.

3. A method according to claim 2, wherein said supramolecular structure is a micelle.

4. A method according to claim 2, wherein said amphiphilic polymer is a reverse thermo-responsive polymer.

5. A method according to claim 2, wherein said liquid environment is an aqueous environment.

6. A method according to claim 4 wherein said polymer comprises polyethylene oxide (PEO).

7. A method according to claim 4, wherein said reverse thermo-responsive polymer comprises a hydrophobic segment selected from the group consisting of poly propylene oxide), poly(tetramethylene oxide), poly(caprolactone), poly(lactic acid) and combinations thereof.

8. A method according to claim 1, wherein said cross-linking comprises functionalizing said polymer with a moiety capable of forming covalent linkage/s under conditions in which said supramolecular structure is not disrupted.

9. A method according to claim 8, wherein said cross-linking comprises the addition reaction of vinyl group or of an acrylic acid derivative.

10. (canceled)

11. A method according to claim 8, wherein said cross-linking comprises a reaction of a methacrylic acid derivative or with a moiety comprising methacrylate.

12. (canceled)

13. A method for manufacturing a polymer nano-structure (nano-shell), wherein said nano-structure is substantially hollow and responds to a temperature change by changing its volume, comprising the steps of:
i) providing a polymer comprising a PEO-PPO-PEO triblock;
ii) end-capping said triblock with methacrylate groups;
iii) mixing the end-capped polymer from step ii) in water at elevated temperature, thereby obtaining an emulsion comprising micelles; and
iv) crosslinking intra-micellarly said methacrylate groups in said micelles, thereby obtaining said hollow nano-shells.

14. A method according to claim 13, wherein said nano-shells are essentially spherical nano-structures or essentially rod-like nano-particles.

15. A method according to claim 14, comprising crosslinking the end-capped polymer at a temperature that is below about 65° C.

16. (canceled)

17. (canceled)

18. A method according to claim 13, wherein said crosslinking reaction occurs, under controlled conditions, partially intermicellarly, thereby obtaining assemblies of said nano-shells.

19. A method according to claim 18, wherein said nano-shells have a morphology of a chain of beads.

20. A method according to claim 13, wherein said end-capped polymer comprises Pluronic™ dimethacrylate.

21. (canceled)

22. A method according to claim 1, wherein said crosslinking occurs by reacting the reactive end groups of said polymer with a difunctional molecule able to react with said end groups under the conditions under which said polymer generates supramolecular structures.

23. A method according to claim 22, wherein said crosslinking reaction occurs between the reactive end groups of said polymer, said reactive end group are selected from the group consisting of hydroxyl, amine, carboxylic acid, carboxylic acid derivatives, vinyl, isocyanatc, halogens and thiol moieties and said difunctional molecule is selected from the group consisting of hydroxyl, amine, carboxylic acid, carboxylic acid derivatives, vinyl, isocyanate, halogens and thiol moieties.

24. A method according to claim 1, wherein said polymer comprises oligopeptide sequences.

25. A method according to claim 1, wherein more than one polymer is used and more than one supramolecular structure is formed.

26. A method according to claim 25, wherein said supramolecular structures shrink and expand at different temperatures.

27. A method according to claim 1, wherein said supramolecular structures comprise more than one polymer.

28. (canceled)

29. A method according to claim 1, wherein said nano-shells comprise more than one polymer.

30. A method according to claim 1, wherein said nano-shells form assemblies comprising more than one nano-shell.

31. A method according to claim 30, wherein said nano-shells form assemblies by reacting one with another.

32. A method according to claim 30, wherein said nano-shells form assemblies by being incorporated into a matrix or into a nanometric or micrometric particle.

33. (canceled)

34. A method according to claim 33, wherein said particle creates a macroscopic structure alone or in combination with another material.

35. (canceled)

36. A method according to claim 30, wherein said nano-shells form assemblies by being incorporated into a nano-fiber.

37. A method according to claim 36, wherein said nano-fibers create a macroscopic structure alone or in combination with an additional material.

38. A polymer nano-structure (nano-shell) comprising a cross-linked supramolecular structure of an amphiphilic polymer.

39. A nano-shell according to claim 38, wherein said supramolecular structure is a micelle.

40. A nano-shell according to claim 38, wherein said amphiphilic polymer is a thermoresponsive polymer.

41. A nano-shell according to claim 38, being substantially hollow, and responding to a temperature change by changing its volume.

42. A nano-shell according to claim 38, wherein said polymer comprises any one of PEO-PPO-PEO triblock and PEO-PPO-PEO triblock grafted with methacryalate moiety.

43. (canceled)

44. A nano-shell according to claim 38, responding to a temperature increase by decreasing its volume.

45. A nano-shell according to claim 38, responding to a temperature decrease by increasing its volume.

46. A nano-shell according to claim 38, wherein said temperature change occurs in a temperature interval of 25 to 45° C.

47. A nano-shell according to claim 38, wherein said temperature change occurs in a temperature interval of 30 to 40° C.

48. A nano-shell according to claim 38, wherein said nano-shell changes its volume by about two or about three orders of magnitude.

49. (canceled)

50. A nano-shell according to claim 38, being biodegradable.

51. A nano-shell according to claim 38, comprising lactoyl or caprolactone units.

52. A nano-shell according to claim 38 for use in sequestering hydrophobic or hydrophilic materials dispersed in an aqueous mixture.

53. A nano-shell according to claim 52, wherein said sequestering comprises concentrating said material, or transporting said material, or scavenging said material.

54. (canceled)

55. A nano-shell according to claim 54, wherein said material is a medicament.

56. A nano-shell according to claim 53, wherein said material is a medically or pharmaceutically undesired component.

57. A nano-shell according to claim 56, for use in scavenging an undesired component, or lowering the concentration thereof, or mitigating a harmful effect thereof.

58. A nano-shell according to claim 38 for use in releasing a pharmaceutically or medically important substance in vivo.

59. A nano-shell according to claim 58, wherein said releasing is associated with decreasing the volume of said nano-shell in response to a temperature increase.
